(19) United States
(12) Patent Application Publication
(10) Pub. No.: US 2011/0129341 A1
(43) Pub. Date: Jun. 2, 2011

(54) METHOD, APPARATUS AND SYSTEM FOR REDUCING VIBRATION IN A ROTARY SYSTEM OF AN AIRCRAFT, SUCH AS A ROTOR OF A HELICOPTER

(75) Inventor: Norbert Seitz, Grobenzell (DE)

(73) Assignee: Prof. Dr.Lars Bertil Carnehammar

(21) Appl. No.: 13/002,751

(22) PCT Filed: Jul. 8, 2009
(86) PCT No.: PCT/EP09/58691

§ 371 Date: Feb. 16, 2011

(30) Foreign Application Priority Data
Jul. 8, 2008 (EP) 08159921.9
Sep. 10, 2008 (EP) 08164059.1
Nov. 12, 2008 (EP) 08168913.5
Apr. 22, 2009 (EP) 09158505.9

(51) Int. Cl. B64C 27/00; B64C 27/473

(52) U.S. Cl. 416/1; 416/144

(57) ABSTRACT

A method for reducing vibration in a rotary system (140; 240a; 240b; 340a; 340b) of an aircraft (100), for example an aeroplane or a rotorcraft, such as a helicopter, comprising balancing said rotary system (140; 240a; 240b; 340a; 340b), characterized by providing a substantially circular chamber (232a, 233a, 234b, 235a, 236a, 237a; 232b, 233b, 234b, 235b, 237b; 335a; 335b; 433a; 433b; 433c; 535a; 535b; 535c) having a fulcrumon an axis (260a; 260b; 360a; 360b; 460a; 460b; 460c; 560a; 560b; 560c) of a shaft (131; 231a; 231b; 331a; 331b; 431a; 431b; 431c; 531a; 531b; 531c) of said rotary system (140; 240a; 240b; 340a; 340b) and being partially filled with an amount of a thixotropic balancing substance (338a; 338b; 438a; 438b; 438c; 538a; 538b; 538c). An apparatus, and a system, for reducing vibration in a rotary system (140; 240a; 240b; 340a; 340b) of an aircraft (100) according to the method.

### FIELD OF THE INVENTION

Embodiments of the invention described herein relate generally to reducing vibration, and more particularly to a method, an apparatus and a system for reducing vibration in a rotary system of an aircraft, such as a rotor of a helicopter.

### BACKGROUND OF THE INVENTION

Vibration is a major environmental factor in aircraft operations. Vibration negatively effects safety and comfort. With regard to safety, vibration has a direct influence on stability and may cause material fatigue. A main source of vibration is a rotary system of the aircraft, for example an engine system of the aircraft, such as a rotor system of a helicopter.

Rotor blades (“blades”) of the helicopter's rotor system may comprise, for example, wood or composite materials, such as glass-fibre-reinforced material or carbon-fibre-reinforced material. The blades change over time, and they tend to get heavier in service. There is blade wear or erosion owing to hard particles, such as sand. Furthermore, owing to light-weight construction of the blades, air cells in the blades may fill with water, in particular where a skin of the blades becomes porous. This is known as water-ingress or trapped-water problem. Furthermore, blades may be repaired during their life time. As a result, a blade's centre of gravity (CofG) moves over time. In general the movement is larger, and therefore more severe, for a span centre of gravity, i.e. in a hub-to-blade-tip direction of the blade, than for a chord centre of gravity, i.e. in a leading-edge-to-tailing-edge direction of the blade. When the chord CofG is located aft of an ideal CofG, a turning moment is located aft of the ideal CofG and, as a consequence, the blade tends to climb. When the chord CofG is located forward of the ideal CofG, the turning moment is located forward of the ideal CofG and, as a consequence, the blade tends to dive. As a consequence, vibration in the rotor system increases.

Helicopter maintenance aims to reduce the vibration and may comprise statically balancing the blades as well as dynamically balancing the rotor system. The static balancing comprises comparing a blade to a master blade. The master blade may be a real, but non-operational blade, such as a beam, made to original specification with regard to mass, ideal span CofG and ideal chord CofG, or a virtual master blade represented in a portable digital weighting system, for example an Universal Static Balance Fixture (USBF). The static balancing enables interchangeability of blades. The dynamic balancing (Rotor Track & Balance “RTB”) comprises testing the blade in the rotor system of the helicopter. The RTB is time-consuming and costly.

Furthermore, effects of the vibration may be reduced by a variety of devices, such as vibration isolators, vibration dampers, vibration absorbers and vibration generators.

US 2008/0142633 A1 and related WO2008060681 disclose helicopter reduced vibration axial support struts and an aircraft suspension system with at least one vibration controlling fluid containing strut. The powered struts include an outer rigid housing containing an inner rigid member and first and second variable volume fluid chambers. Fluid pressure differentials are created between the first and second variable volume fluid chambers to control motion between the strut ends. The powered fluid containing struts, support isolators, suspension systems, and methods of operation provide reduced helicopter aircraft vibrations.

U.S. Pat. No. 6,938,888 discloses a vibration damper, in particular for a helicopter rotor, the damper comprising both a driving element and a rigid element and including a damper assembly functionally interconnecting the driving element and the rigid element, the damper assembly comprising firstly a hydraulic damper device disposed in at least one viscous fluid cavity and a laminated flexible device. The hydraulic damper device comprises first and second sets of interleaved plane vanes. The hydraulic damper device also has at least one damper element which is disposed in one of said viscous fluid cavities and which is secured to the driving element, said damper element presenting an outer outline which tapers going away from a base situated beside one axial end of the damper towards an apex situated beside the sets of plane vanes.

U.S. Pat. No. 7,153,094 discloses a rotor system vibration absorber for use with a helicopter or other rotorcraft in which spring forces are provided by a plurality of elongated rods arranged in a selected pattern. The rods are coupled at one end to a fixed base that is coupled to a rotor hub, and at the other end to a tuning weight.

WO 2006135405 discloses a helicopter rotating hub mounted vibration control system for a helicopter rotary wing hub having a periodic vibration while rotating at a helicopter operational rotation frequency. The helicopter rotating hub mounted vibration control system includes an annular ring rotary housing attachable to the helicopter rotary wing hub and rotating with the helicopter rotary wing hub at the helicopter operational rotation frequency. The annular ring housing is centred about the rotary wing hub axis of rotation and has an electronics housing cavity subsystem and preferably an adjacent coaxial rotor housing cavity subsystem. The rotor housing cavity subsystem contains a first coaxial frameless AC ring motor having a first rotor with a first imbalance mass and a second coaxial frameless AC ring motor having a second rotor with a second imbalance mass. The electronics housing cavity subsystem contains an electronics control system which receives sensor outputs and electrically controls and drives the first coaxial frameless AC ring motor and the second coaxial frameless AC ring motor such that the first imbalance mass and the second imbalance mass are directly driven at a vibration cancelling rotation frequency greater than the helicopter operational rotation frequency wherein the helicopter rotary wing hub periodic vibration is reduced.

GB 2100388 A discloses a vibration absorber for attachment to a vibrating component such as rotatable shaft including a fluid container partially filled with fluid which is urged outwardly during rotation. Inward reaction of the fluid results in resonant waves in the fluid which may be tuned to balance unwanted lateral radial vibration forces. The fluid is water. The absorber is particularly suitable for attachment to the rotor assembly of a helicopter to overcome the problem of the high rotor derived vibration levels transmitted to the fuselage of such aircraft. The resonant frequency of such an absorber varies with rotational speed and may be made self tuning over a range of rotor speeds.

WO 2008009696 A1 discloses an invention relating to automobile tyres or tyre assemblies or parts thereof suitable for being balanced by introduction therein of a thixrotropic balancing gel, wherein surfaces of the tyre or tyre assembly or part thereof which are intended to be in contact with the balancing gel are provided with a surface nanostructure with an average surface roughness in the range of 1-1000 nm. The surface nanostructure will enable the thixotropic balancing gel to move to the location, where it balances the tyre, significantly quicker than if the surface in question did not have the surface nanostructure.

EP 0281252 A1 discloses a thixotropic tyre balancing composition having a yield stress value between 30 Pa and 260 Pa, preferably about 120 Pa, is capable of balancing tyres by being able to flow under the influence of the vibrations induced when a heavy spot on the tyre hits the road surface. The balancing composition distributes itself in a wheel assembly consisting of a tyre mounted on a rim and having a heavy spot. The composition preferably comprises a mixture of: 1) a liquid di- or trihydric alcohol or a di-, tri- or tetrameric oligomer thereof, optionally containing water; 2) a polymer soluble or dispersible in the alcohol; 3) hydrophilic fibers; and optionally, 4) a hydrophilic filler. The alcohol 1) is preferably a diol of the general formula HO—(CH(R)—CH2-O)ₙ—H wherein R is hydrogen or C1-2 alkyl and n is an integer from 1 to 4.

U.S. Pat. No. 2,836,083 discloses a balancing system for a container which is adapted to be rapidly rotated to extract liquid from the material contained therein to effect at least a partial drying thereof. A thixotropic material is disposed in the interior of a hollow, toroidal tubular balancing member. One satisfactory mixture utilized as balancing material is made up of 93.5% by weight acetylene tetra bromide, 1.5% by weight Santocel and 5% by weight basic lead carbonate.

U.S. Pat. No. 5,540,767 discloses visco-elastic tyre balancing compositions comprising (A) 80-95% w/w of an oil selected from i. a. polypropyleneglycol alkyl ethers, and (B) 4-15% w/w of a gel former selected from i. a. fumed silica having a BET surface in the range of from about 50 to about 400 m²/g.

For these and other reasons, there is a need for the invention as set forth in the following in the embodiments.

### SUMMARY OF THE INVENTION

The invention aims to provide a method, an apparatus and a system reducing vibration in a rotary system of an aircraft, such as a rotor of a helicopter.

An aspect of the invention is a method for reducing vibration in a rotary system 140; 240a; 240b; 340a; 340b of an aircraft 100, for example an aeroplane or a rotorcraft, such as a helicopter, comprising balancing said rotary system 140; 240a; 240b; 340a; 340b, characterized by providing a substantially circular chamber 232a, 233a, 234b, 235a, 236a, 237a; 232b, 233b, 234b, 235b, 237b; 335a; 335b; 433a; 433b; 433c; 535a; 535b; 535c having a fulcrum on an axis 260a; 260b; 360a; 360b; 460a; 460b; 460c; 560a; 560b; 560c of a shaft 131; 231a; 231b; 331a; 331b; 431a; 431b; 431c; 531a; 531b; 531c of said rotary system 140; 240a; 240b; 340a; 340b and being partially filled with an amount of a thixotropic balancing substance 338a; 338b; 438a; 438b; 438c; 538a; 538b; 538c. The rotary system 140; 240a; 240b; 340a; 340b may be an engine, for example a propeller engine or jet engine, of the aeroplane or a lift rotor or tail rotor of the helicopter. The thixotropic balancing substance 338a; 338b; 438a; 438b; 438c; 538a; 538b; 538c is able to flow under the influence of the vibration induced by the rotary system 140; 240a; 240b; 340a; 340b. Hence, owing to the vibration, the thixotropic balancing substance 338a; 338b; 438a; 438b; 438c; 538a; 538b; 538c distributes itself in the chamber 232a, 233a, 234b, 235a, 236a, 237a; 232b, 233b, 234b, 235b, 237b; 335a; 335b; 433a; 433b; 433c; 535a; 535b; 535c to reduce or minimize the vibration. As a consequence, a centre of rotation (CofR) of the rotary system moves towards an ideal CofR, and the method compensates for migration of the CofG. As a further consequence, vibration is reduced, and, as a result, safety is increased, stability is increased and material fatigue is reduced. As a further result, comfort is improved, noise is reduced and, thus, acoustics inside as well as outside the aircraft 100 is improved. Furthermore, wear and tear of the aircraft 100, in particular of the rotary system 140; 240a; 240b; 340a; 340b, is reduced.

Another aspect of the invention is a method, wherein said chamber 233a, 234b, 235a, 236a, 237a; 335a; 335b; 433a; 433b; 433c is cylindrical. As a consequence, the chamber 233a, 234b, 235a, 236a, 237a; 335a; 335b; 433a; 433b; 433c may be compact, and as a result, the chamber 233a, 234b, 235a, 236a, 237a; 335a; 335b; 433a; 433b; 433c may require little space.

Another aspect of the invention is a method, wherein said chamber 232b, 233b, 234b, 235b, 237b; 535a; 535b; 535c is annular, said chamber 232b, 233b, 234b, 235b, 237b; 535a; 535b; 535c preferably having a cross section being rectangular 535a, semicircle-shaped 535b, bell-shaped 535b or circular 535c. As a consequence, the chamber 232b, 233b, 234b, 235b, 237b; 535a; 535b; 535c may allow, owing to a larger diameter, for an efficient use of the thixotropic balancing substance 538a; 538b; 538c, and as a result, the amount of the thixotropic balancing substance 538a; 538b; 538c may be reduced. As a further consequence, owing to the cross section being rectangular 535a, semicircle-shaped 535b or bell-shaped 535b, the thixotropic balancing substance 538a; 538b; 538c may operate most effective, and as a further result, the amount of the thixotropic balancing substance 538a; 538b; 538c may further be reduced. As a further consequence, owing to the cross section being circular 535c, an air resistance may be reduced, and as a further result, stability may be improved.

Another aspect of the invention is a method, wherein said chamber 237a; 237b is located above blades 241a; 241b of said rotary system 140; 240a; 240b. As a consequence, the thixotropic balancing substance 338a; 338b; 438a; 438b; 438c; 538a; 538b; 538c operates towards a first free end of the shaft 131; 231a; 231b; 331a; 331b; 431a; 431b; 431c; 531a; 531b; 531c, where an amplitude of the vibration may reach a maximum, and as a result, an effect of balancing may be maximized.

Another aspect of the invention is a method, wherein said chamber 235a; 235b is located below said blades 241a; 241b. As a consequence, the chamber 235a; 235b may be located in the rotary system 140; 240a; 240b, and as a result, the chamber 235a; 235b may not impact on overall dimensions of the aircraft 100.

Another aspect of the invention is a method, wherein said chamber 235a; 235b is located above a power plant 230a; 230b of said aircraft 100. As a consequence, the chamber 235a; 235b may be located in the aircraft 100, and as a result, the chamber 235a; 235b may be protected by the aircraft 100.

Another aspect of the invention is a method, wherein said chamber 232a; 232b is located in said power plant 230a; 230b. As a consequence, vibration originating from the power plant 230a; 230b may be reduced, and as a result, wear and tear of power plant 230a; 230b may be reduced.

Another aspect of the invention is a method, wherein said chamber 232a; 232b is located below said power plant 230a; 230b. As a consequence, the thixotropic balancing substance 338a; 338b; 438a; 438b; 438c; 538a; 538b; 538c operates towards a second end of the shaft 131; 231a; 231b; 331a; 331b; 431a; 431b; 431c; 531a; 531b; 531c, and as a result, balancing may be maximized, and as a result, the effect of balancing may be improved.

Another aspect of the invention is a method, wherein said chamber 233a, 234b, 235a, 236a, 237a; 232b, 233b, 234b, 235b, 237b; 335a; 335b; 433a; 433b; 433c; 535a; 535b; 535c comprises a circumferential balancing area 339a; 339b; 439a; 439b; 439c; 539a; 539b; 539c with a nanostructure, said nanostructure being, for example, formed by a material, such as a varnish, comprising nanoparticles, or imprinted on said balancing area 339a; 339b; 439a; 439b; 439c; 539a; 539b; 539c. The nanostructure may be provided by distributing, for example spraying and drying or hardening, the material on the balancing area. Drying or hardening may comprise curing nanomaterial, that is the nanovarnish, using ultra-violet (UV) radiation, that is UV light, for example. The material, that is the nanomaterial, may provide the nanostructure as nanosubstrate. The nanomaterial may comprise two or more components, for instance a first component A, for example a resin, and a second component B, for example a hardener. The nanomaterial may be a two-component material. The nanomaterial, that is the first component A and the second component B, may react by chemical crosslinking or polymerisation. The chemical crosslinking reaction may start immediately or soon after mixing the first component A and the second component B. As a consequence, movability of the thixotropic balancing substance 338a; 338b; 438a; 438b; 438c; 538a; 538b; 538c on the balancing area 339a; 339b; 439a; 439b; 439c; 539a; 539b; 539c may increase, and as a result, the effect of balancing may be improved.

Another aspect of the invention is a method, wherein said shaft 131; 231a; 231b; 331a; 331b; 431a; 431b; 431c; 531a; 531b; 531c comprises metal, for example steel or aluminium, or composite material, for example glass-fibre-reinforced material or carbon-fibre-reinforced material, or synthetic material, for example plastics or plexiglass. The material is preferably material used elsewhere in the aircraft 100, in particular in the rotary system 140; 240a; 240b; 340a; 340b. As a consequence, problems owing to incompatibility may be avoided, and as a result, life time of the aircraft 100 may be improved and maintenance may be simplified.

Another aspect of the invention is a method, wherein said chamber 232a, 233a, 234b, 235a, 236a, 237a; 433a; 433b; 433c is situated in said shaft 231a; 231b; 431a; 431b; 431c, said shaft 231a; 431a; 431b; 431c preferably replacing an original shaft of said rotary system 140; 240a. As a consequence, the chamber 232a, 233a, 234b, 235a, 236a, 237a; 433a; 433b; 433c may not require space of its own, and as a result, the chamber 232a, 233a, 234b, 235a, 236a, 237a; 433a; 433b; 433c may be easy to introduce into aircraft design. As a further consequence, the shaft 231a; 431a; 431b; 431c may be compatible with the original shaft, and as a result, the shaft 231a; 431a; 431b; 431c may be used for upgrading the aircraft 100.

Another aspect of the invention is a method, wherein said chamber 232a, 233a, 234a, 235a, 236a, 237a; 433a; 433b; 433c preferably extending substantially along said shaft 231a; 431a; 431b; 431c. As a consequence, the chamber 232a, 233a, 234a, 235a, 236a, 237a; 433a; 433b; 433c may comprise a larger amount of the thixotropic balancing substance 438a; 438b; 438c, and as a result, the effect of the balancing may be improved.

Another aspect of the invention is a method, wherein said chamber 232b, 233b, 234b, 235b, 237b; 335a; 335b; 535a; 535b; 535c is situated in a vessel being coupled to said shaft 231a; 331a; 331b; 531a; 531c; 531c, said vessel preferably supplementing said rotary system 140; 240b; 340a; 340b. As a consequence, the chamber 232b, 233b, 234b, 235b, 237b; 335a; 335b; 535a; 535b; 535c may be more flexible and easier to access, and as a result, the vessel may be easier to implement. As a further consequence, the shaft 231a; 431a; 431b; 431c may not need to be replaced, and as a result, the vessel may be used for re-fitting the aircraft 100.

Another aspect of the invention is a method, wherein said vessel has a diameter of between approximately 0.1 m and approximately 10 m, for example between approximately 0.2 m and approximately 1.5 m, preferably between approximately 0.5 m and approximately 1 m, such as approximately 0.75 m. The effect for a given amount of the thixotropic balancing substance 338a; 338b; 438a; 438b; 438c; 538a; 538b; 538c is greater for a larger diameter than for a smaller diameter. However, the diameter may be determined by available space.

Another aspect of the invention is a method, wherein said vessel comprises metal, for example steel or aluminium, or composite material, for example glass-fibre-reinforced material or carbon-fibre-reinforced material, or synthetic material, for example plastics or plexiglass. The material is preferably material used elsewhere in the aircraft 100, in particular in the rotary system 140; 240a; 240b; 340a; 340b. As a consequence, problems owing to incompatibility may be avoided, and as a result, life time of the aircraft 100 may be improved and maintenance may be simplified.

Another aspect of the invention is a method, wherein said vessel is coupled to said shaft 231a; 331a; 331b via said blades 141, a disc 570a; 570b; 570c or spokes 570a; 570b; 570c, said spokes 570a; 570b; 570c preferably being evenly spaced apart from each other. As a consequence, the blades 141 may be utilized, preferably when the rotary system 140; 240a; 240b; 340a; 340b, such as the tail rotor, has a relatively small diameter, for coupling the vessel to the shaft 231a; 331a; 331b, and as a result, construction of the rotary system 140; 240a; 240b; 340a; 340b may be simplified. As a further consequence, the disc 570a; 570b; 570c or spokes 570a; 570b; 570c may be utilized, preferably when the rotary system 140; 240a; 240b; 340a; 340b, such as the lift rotor, has a relatively large diameter, for coupling the chamber 232b, 233b, 234b, 235b, 237b; 335a; 335b; 535a; 535b; 535c to the shaft 231a; 331a; 331b, and as a further result, construction of the rotary system 140; 240a; 240b; 340a; 340b may be simplified. As a further consequence, imbalance of the spokes 570a; 570b; 570c may be reduced, and as a further result, the effect of the balancing may be improved.

Another aspect of the invention is a method, wherein said thixotropic balancing substance 338a; 338b; 438a; 438b; 438c; 538a; 538b; 538c has a yield stress value between approximately 1 Pa and approximately 400 Pa, for example between approximately 2 Pa and approximately 260 Pa, such as approximately 30 Pa. As a consequence, distribution of the thixotropic balancing substance 338a; 338b; 438a; 438b; 438c; 538a; 538b; 538c may be improved, and as a result, the effect of the balancing may be improved.

Another aspect of the invention is a method, wherein said thixotropic balancing substance 338a; 338b; 438a; 438b; 438c; 538a; 538b; 538c is a balancing gel composition comprising

1) 85 to 97% by weight of a glycol ether component comprising one or more ethylene/propylene glycol copolymer ethers of the general formula (I) or the general (II) or mixtures thereof.

R—O{[CH(CH3)CH2-O-]m[CH2—CH2-O-]n}H (I)

R1-(O—{[CH(CH3)CH2-O-]m[CH2-CH2-O-]n}H)2 (II)
wherein
R is hydrogen or an alkyl group of 2-8 carbon atoms;
R1 is an alkylene moiety of 2-8 carbon atoms in which the two substituents are not carried on the same carbon atom;
m is the mole percentage of propylene glycol in the ethylene/propylene glycol copolymer moiety or moieties; and
n is the mole percentage of ethylene glycol in the ethylene/propylene glycol copolymer moiety or moieties, wherein the ratio n:m is in the range from 35:65 to 80:20;
each glycol copolymer compound having a number average molecular weight in the range of 2000-10000; and
   2) 3 to 15% by weight of a fumed silica gel former;
said balancing composition being visco-elastic and having a storage modulus (G′) between 1500 Pa and 5000 Pa at 22° C., a loss modulus (G″) smaller than the storage modulus up to a cross-over Frequency of 10-40 Hz, and a Critical Yield Stress exceeding 2 Pa.

Another aspect of the invention is a method, wherein the number average molecular weight of the glycol ether component(s) is/are in the range of 3000-10000.

Another aspect of the invention is a method, wherein the ratio n:m is in the range from 35:65 to 80:20, preferably in the range from 40:60 to 75:22, in particular from 40:60 to 60:40, such as 50:50.

Another aspect of the invention is a method, wherein the fumed silica gel former is a hydrophilic type fumed silica having a BET surface area of from 90 to 400 m²/g, preferably from 200 to 300 m²/g; or the fumed silica gel former is a hydrophobized type fumed silica having has a BET surface area of from 50 to 300 m²/g, preferably from 250 to 350 m²/g; or mixtures of such hydrophilic and hydrophobized type fumed silica gel formers.

Another aspect of the invention is a method, wherein the glycol ether component(s) exhibit(s) a Viscosity Grade determined according to 1503448 of above 500, preferably in the range of 800-1200.

Another aspect of the invention is a method, wherein said amount of said thixotropic balancing substance 338a; 338b; 438a; 438b; 438c; 538a; 538b; 538c is between approximately 0.01 kg and approximately 20 kg, for example between approximately 0.1 kg and approximately 2 kg, preferably between approximately 0.2 kg and approximately 1 kg, such as approximately 0.5 kg.

Another aspect of the invention is a method, wherein said chamber 232a, 233a, 234b, 235a, 236a, 237a; 232b, 233b, 234b, 235b, 237b; 335a; 335b; 433a; 433b; 433c; 535a; 535b; 535c is filled with said amount of said thixotropic balancing substance 338a; 338b; 438a; 438b; 438c; 538a; 538b; 538c to between approximately 1% and approximately 90%, for example between approximately 10% and approximately 80%, preferably between approximately 25% and approximately 75%, such as approximately 50%.

Another aspect of the invention is a method, wherein a weight body is in contact with said thixotropic balancing substance 338a; 338b; 438a; 438b; 438c; 538a; 538b; 538c. As a consequence, the weight body may contribute to balancing of the rotary system 140; 240a; 240b; 340a; 340b, and as a result, the effect of the balancing may be improved, and the amount of said thixotropic balancing substance 338a; 338b; 438a; 438b; 438c; 538a; 538b; 538c may be reduced.

Another aspect of the invention is a method, wherein said weight body has, defined by a body size of said weight body, a body surface and a body weight, such that said weight body overcomes adhesion between said body surface and said thixotropic balancing substance 338a; 338b; 438a; 438b; 438c; 538a; 538b; 538c when said thixotropic balancing substance 338a; 338b; 438a; 438b; 438c; 538a; 538b; 538c is subjected to said vibration and changes in an agitated state. As a consequence, the body size ensures movability of the weight body in the chamber 232a, 233a, 234b, 235a, 236a, 237a; 232b, 233b, 234b, 235b, 237b; 335a; 335b; 433a; 433b; 433c; 535a; 535b; 535c with the thixotropic balancing substance 338a; 338b; 438a; 438b; 438c; 538a; 538b; 538c therein, and as a result, the effect of the balancing may be improved.

Another aspect of the invention is a method, wherein said weight body preferably is a ball. The body size corresponds with a diameter of the ball. The diameter may be determined by a ratio between the body surface according to A=4 pi r̂2 accounting for surface structure, i.e. roughness, and adhesion, and a body volume according to V=4/3 pi r̂3 accounting for body density and body weight. For increasing radius r, the body volume, and therefore body, weight increases faster than the body surface. As a consequence, movability of the weight body in the chamber 232a, 233a, 234b, 235a, 236a, 237a; 232b, 233b, 234b, 235b, 237b; 335a; 335b; 433a; 433b; 433c; 535a; 535b; 535c may be increased, and as a result, the effect of the balancing may be improved.

Another aspect of the invention is a method, wherein said weight body comprises metal, for example steel, such as stainless steel. As a consequence, durability of the weight body in the chamber 490; 590; 690; 790; 890a-c; 990; 1090; 1190; 1250, 1260, 1290; 1390 may be improved, and as a result, maintenance work may be simplified and reduced.

A further aspect of the invention is an apparatus for reducing vibration in a rotary system 140; 240a; 240b; 340a; 340b of an aircraft 100 according to the method.

Yet a further aspect of the invention is a system for reducing vibration in a rotary system 140; 240a; 240b; 340a; 340b of an aircraft 100 according to the method.

### BRIEF DESCRIPTION OF THE SEVERAL VIEWS OF THE DRAWING(S)

While the specification concludes with claims particularly pointing out and distinctly claiming that which is regarded as the invention, a more particular description of the invention will be rendered by reference to specific embodiments thereof, which are depicted in the appended drawings, in order to illustrate the manner in which embodiments of the invention are obtained. Understanding that these drawings depict only typical embodiments of the invention, that are not necessarily drawn to scale, and, therefore, are not to be considered limiting of its scope, embodiments will be described and explained with additional specificity and detail through use of the accompanying drawings in which:

FIG. 1 shows a schematic view of a rotorcraft;

FIG. 2 a) shows several locations of a chamber in a shaft according to an embodiment of the invention;

FIG. 2 b) shows several locations of a chamber in a vessel according to another embodiment of the invention;

FIGS. 3 a) and b) show, for a preferred embodiment of the invention, a cross-sectional schematic view of a cylindrical chamber for several points in time and a corresponding view on the cylindrical chamber at a particular point in time, respectively;

FIG. 4 a) to c) show cross-sectional schematic views of several embodiments of a chamber in a shaft; and

FIG. 5 a) to c) show cross-sectional schematic views of several embodiments of a chamber in a vessel; and

FIG. 6 shows a comparative representation of root mean square (RMS) accelerations in acceleration of gravity (g) of a model helicopter without and with a balancing substance over time (t) in seconds (s).

### DETAILED DESCRIPTION OF THE INVENTION

In the following detailed description of the embodiments, reference is made to the accompanying drawings which form a part hereof and show, by way of illustration, specific embodiments in which the invention may be practiced. In the drawings, like numerals describe substantially similar components throughout the several views. The embodiments are intended to describe aspects of the invention in sufficient detail to enable those of skill in the art to practice the invention. Other embodiments may be utilized and structural, logical or electrical changes or combinations thereof may be made without departing from the scope of the invention. Moreover, it is to be understood, that the various embodiments of the invention, although different, are not necessarily mutually exclusive. For example, a particular feature, structure or characteristic described in one embodiment may be included within other embodiments. Furthermore, it is to be understood, that embodiments of the invention may be implemented using different technologies. Also, the term “exemplary” is merely meant as an example, rather than the best or optimal. The following detailed description is, therefore, not to be taken in a limiting sense, and the scope of the invention is defined only by the appended claims, along with the full scope of equivalents to which such claims are entitled.

Reference will be made to the drawings. In order to show the structures of the embodiments most clearly, the drawings included herein are diagrammatic representations of inventive articles. Thus, actual appearance of the fabricated structures may appear different while still incorporating essential structures of embodiments. Moreover, the drawings show only the structures necessary to understand the embodiments. Additional structures known in the art have not been included to maintain clarity of the drawings. It is also to be understood, that features and/or elements depicted herein are illustrated with particular dimensions relative to one another for purposes of simplicity and ease of understanding, and that actual dimensions may differ substantially from that illustrated herein.

In the following description and claims, the terms “include”, “have”, “with” or other variants thereof may be used. It is to be understood, that such terms are intended to be inclusive in a manner similar to the term “comprise”.

In the following description and claims, the terms “coupled” and “connected”, along with derivatives such as “communicatively coupled” may be used. It is to be understood, that these terms are not intended as synonyms for each other. Rather, in particular embodiments, “connected” may be used to indicate, that two or more elements are in direct physical or electrical contact with each other. However, “coupled” may also mean that two or more elements are not in direct contact with each other, but yet still co-operate or interact with each other.

In the following description and claims, terms, such as “upper”, “lower”, “first”, “second”, etc., may be only used for descriptive purposes and are not to be construed as limiting. The embodiments of a device or article described herein can be manufactured, used, or shipped in a number of positions and orientations.

In the present context, the term “nanostructure” is to be understood as referring to any surface structure which has surface details of a size in the nanometre range.

Aircraft comprise lighter-than air aircraft (“aerostats”) and heavier-than-air aircraft “aerodynes”. Aerostats comprise balloons and airship. Aerodynes comprise aeroplanes having fixed wings and rotorcraft (“rotary wing aircraft”) having wing-shaped rotors (“rotary wings”). Aeroplanes may generally have, for example, a propeller engine or jet engine, such as a turbojet, turbofan, pulse jet, ramjet and scramjet engine. Rotorcrafts comprise helicopters, autogyros (“gyroplanes”), gryodynes and tiltrotors. Helicopters generally have one or more main rotors (“lift rotors”) powered by a power plant, each main rotor having two or more blades. Thus, helicopters may have a horizontal rotor as a single main rotor, and a tail rotor, a ducted fan or no tail rotor (“NOTAR”). Alternatively, helicopters may have two horizontal rotors as contra-rotating dual rotors in tandem, coaxial, intermeshing or transverse configuration. Autogyros generally have an unpowered rotor and a separate power plant for providing thrust. Aircraft may be manned or unmanned (remotely piloted vehicle “RPV” or unmanned aerial vehicle “UAV”). Unmanned aircraft comprise, for example, model aircraft, such as model helicopters.

Thus, a rotary system of an aircraft may be, for example, the propeller or jet engine of an aeroplane, the main rotor of a helicopter or the rotor of an autogyro.

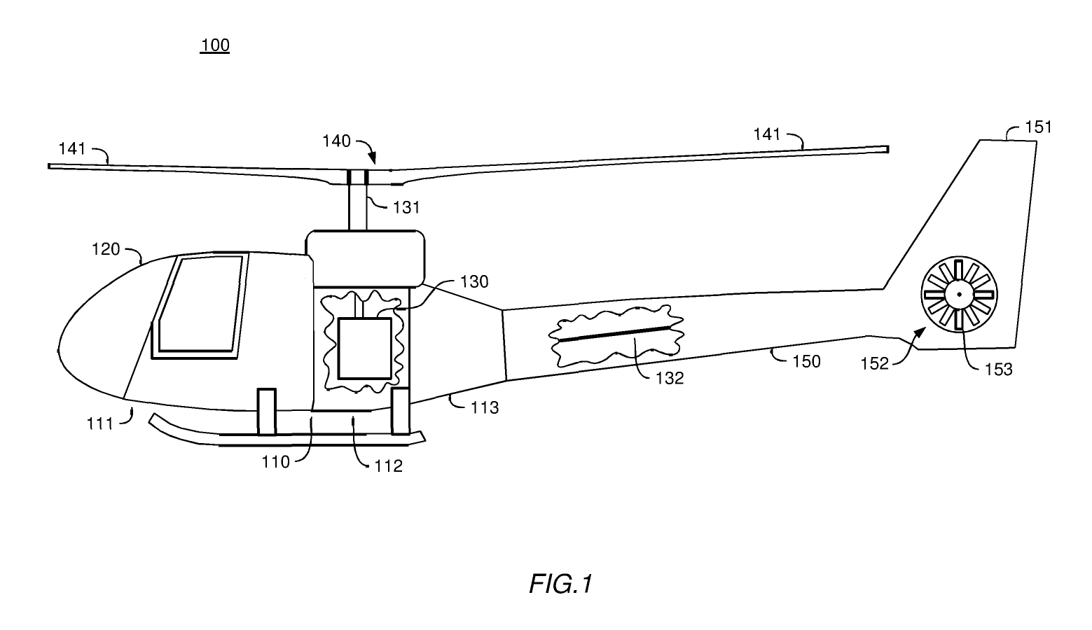

FIG. 1 shows a schematic view of a rotorcraft 100, such as a helicopter, to which the invention may be applied. The rotorcraft 100 comprises a fuselage 110 comprising, in its front section 111, a cockpit 120, in its intermediate section 112, a power plant 130. The power plant 130 is coupled via a shaft, such as a mast 131, to a lift rotor 140 comprising blades 141, and adapted to provide rotation of the lift rotor 140. The fuselage 110 is, at its rear section 113, extended to a tail boom 150 comprising, at a free aft end, a fin 151 and a tail rotor 152 comprising blades 153 and adapted to provide anti-torque. The power plant 130 is coupled via a rotary shaft 132 to the tail rotor 152.

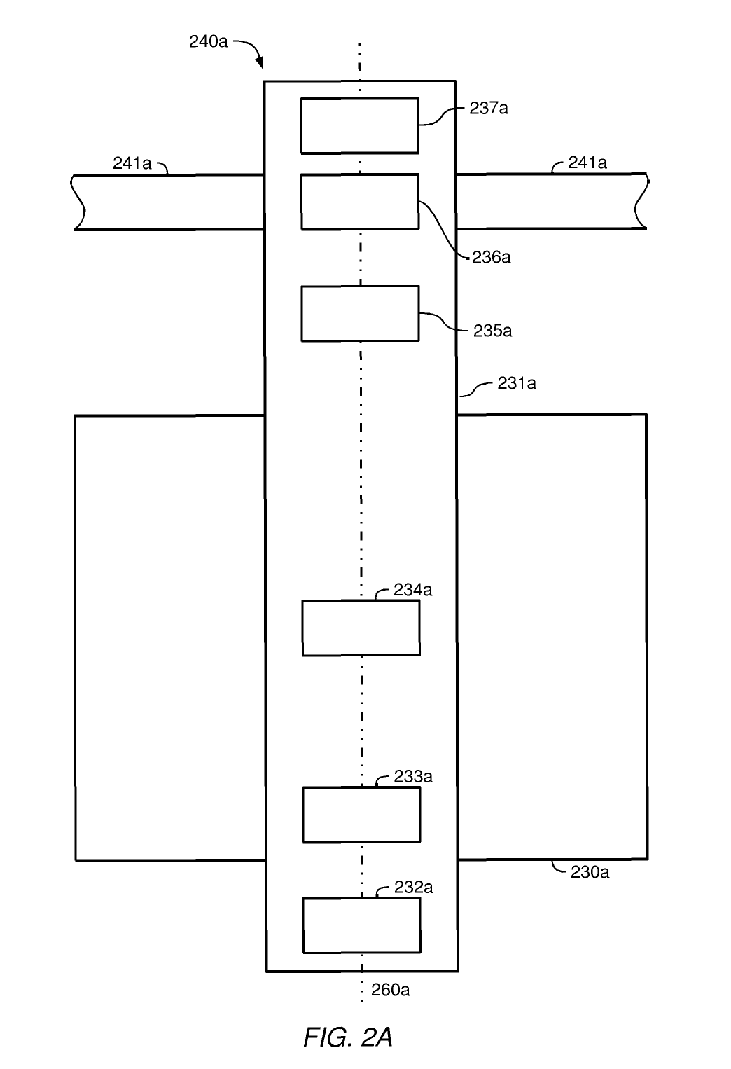

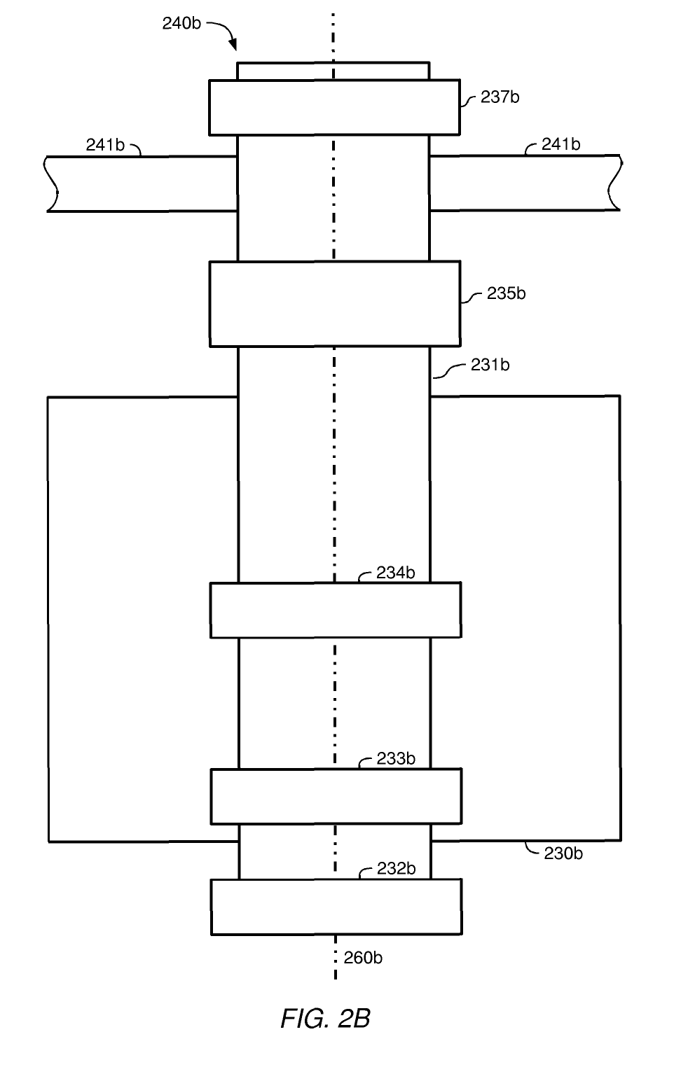

FIG. 2 a) shows several locations of a chamber in a shaft 240a according to an embodiment of the invention. The chamber 237a may be located in the shaft 231a above the blades 241a of the rotary system 240a. As a consequence, a thixotropic balancing substance (not shown) operates towards a first free end of the shaft 231a, where an amplitude of the vibration may reach a maximum, and as a result, an effect of balancing may be maximized. Alternatively, the chamber 236a may be located in the shaft 231a on level with the blades 241a of the rotary system 240a. Alternatively, the chamber 235a may be located in the shaft 231a below the blades 241a. Alternatively, the chamber 235a may be located in the shaft 231a above a power plant 230a. Alternatively, the chamber 234a; 233a may be located in the shaft 231a on level with the power plant 230a. Alternatively, the chamber 232a may be located in the shaft 231a below the power plant 230a. Alternatively, the shaft 231a may comprise a number of chambers 232a, 233a, 234a, 235a, 236a, 237a.

FIG. 2 b) shows several locations of a chamber in a vessel according to another embodiment of the invention. The chamber 237b may be located in a vessel coupled to a shaft 231b above the blades 241b of the rotary system 240b. As a consequence, a thixotropic balancing substance (not shown) operates towards a first free end of the shaft 231b, where an amplitude of the vibration may reach a maximum, and as a result, an effect of balancing may be maximized. Alternatively, the chamber 235b may be located in a vessel below the blades 241b. Alternatively, the chamber 235b may be located in a vessel above a power plant 230b. Alternatively, the chamber 234b; 233b may be located in a vessel on level with the power plant 230a. Alternatively, the chamber 232b may be located in a vessel below the power plant 230a. Alternatively, a number of vessels may comprise a number of chambers 232b, 233b, 234b, 235b, 237a.

Alternatively, a shaft may comprise a number of chambers and a number of vessels may comprise a number of chambers.

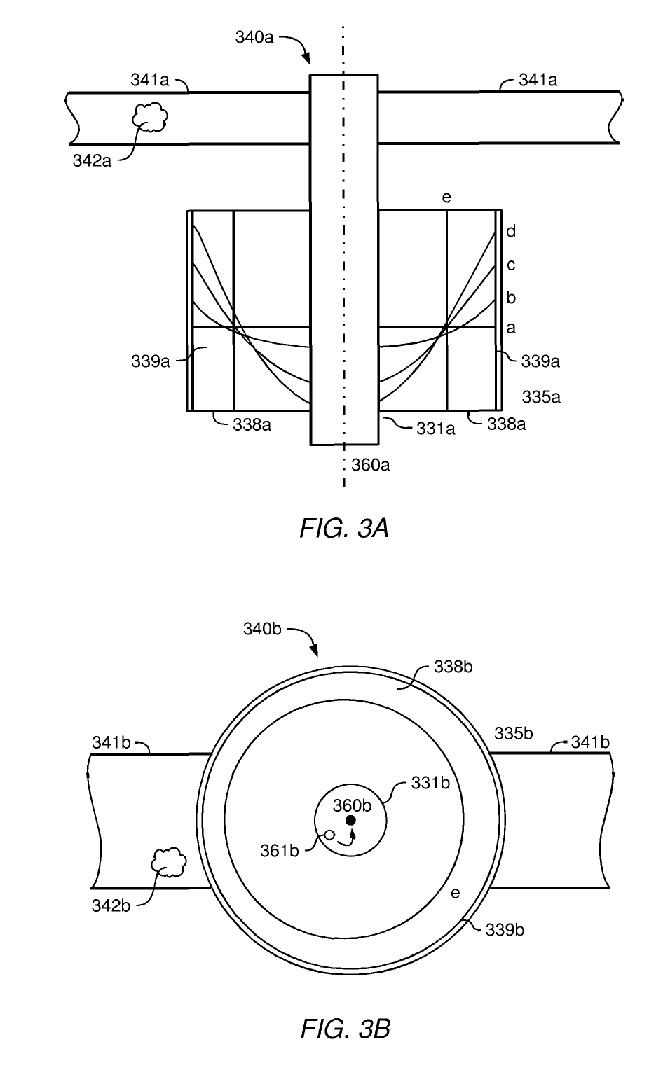

FIGS. 3 a) and b) show, for a preferred embodiment of the invention, a cross-sectional schematic view of a cylindrical chamber 335a for several points “a”, “b”, “c”, “d”, “e” in time and a corresponding view on the cylindrical chamber 335b at a particular point “e” in time, respectively.

FIG. 3 a) shows a cross-sectional schematic view of the cylindrical chamber 335a for several points a, b, c, d, e in time. A rotary system 340a comprises a shaft 331a and blades 341a. One of the blades 341a comprises a heavy spot 342a caused, for example, by water trapping. The chamber 335a is situated in a vessel being coupled to the shaft 331a extending trough the vessel. The vessel may be implemented as a cup-like lower part and a lid-like upper part. The upper part may be fastened to the lower part with a number of fastening means, such as screws. The fastening means may be evenly spaced apart. The vessel provides a closed system.

The chamber 335a is partially filled with an amount of a thixotropic balancing substance 338a, such as a thixotropic tyre balancing composition disclosed in EP patent application 0 281 252 and corresponding U.S. Pat. No. 4,867,792, having a yield stress value between 1 Pa and 260 Pa being capable of balancing tyres by being able to flow under the influence of the vibrations induced when a heavy spot on the tyre hits the road surface. Alternatively, the thixotropic balancing substance 338a may have a yield stress value greater than 2 Pa. However, owing to the lower yield stress value, a lower rotational acceleration may be necessary, especially if the shaft 331a is not in a vertical position.

Rheological properties of a balancing substance are its Critical Yield Stress (CYS) and Elastic (Storage) Modulus (G′), both measured in the linear visco-elastic region, as well as its Yield Stress as determined in stress growth measurements and the relationship between its storage modulus (G′) and its loss modulus (G″), measured by a frequency sweep.

Storage modulus (G′) is a measure of the strength of the substance, that is the strength and the number of bonds between the molecules of the gel former.

Loss modulus (G″) is a measure of a substance's ability to dissipate energy in the form of heat.

The relationship between G′ and G″ as measured in a frequency sweep is a structural characterization of a substance. The cross-over frequency is the frequency at which G″ becomes greater than G′.

Of equal importance as the visco-elastic properties is a long term stability of the balancing substance in service, the performance at various temperatures of the substance, and the chemical inertness of the substance.

A balancing substance should remain functional during the life time of the balancing system and under the various conditions, in particular within a temperature range from approximately −50° C. or −30° C. to +90° C.

Furthermore, the balancing substance must not have any harmful effect on the balancing system and environment and should be disposable or recyclable.

In more detail, the thixotropic balancing substance 338a may be a balancing gel comprising two components, namely, a base liquid and a gel former, and preferably fulfilling minimum criteria comprising, the regard to rheology, a storage modulus (G′) between approximately 100 Pa and approximately 5000 Pa, a cross-over frequency (G″>G′) between approximately 1 Hz and approximately 40 Hz and a critical yield stress value greater than approximately 1 Pa; with regard to volatility, an evaporation loss of less than approximately 6% by weight after 10 hours at 99° C.; a pour point of the base liquid lower than approximately −15° C. according to the Standard Test Method for Pour Point of Petroleum Products, ASTM D97; with regard to separation stability, a separation of the base liquid of less than approximately 20% by weight after 12 hours at 300 000×g and 25° C.; and, with regard to chemical reactivity, substantial inertness, such as non-corrosiveness to metals and no effect on polymers, such as rubber. The balancing gel typically comprises, by weight, between approximately 75% and approximately 99%, for example between approximately 85% and approximately 97%, such as approximately 95% of the base liquid, and, correspondingly, between approximately 1% and approximately 25%, for example between approximately 3% and approximately 15%, such as approximately 5% of the gel former. The balancing gel may further comprise, preferably in minor amounts, a corrosion inhibitor, an anti-oxidant, a dye or a combination thereof.

The base liquid may, for example, comprise a polyalkylene glycol (PAG), such as a polypropylene glycol (PPG) or a polyethylene glycol (PEG); a combination, that is a mixture, of PAGs, such as a combination of a PPG and a PEG; a copolymer of ethylene oxide and propylene oxide; or a combination thereof.

The base liquid may comprise an alcohol-(ROH—) started polymer of oxypropylene groups having a generalized formula:

RO—[CH(CH₃)CH₂—O—]ₘH, (1)

where R is hydrogen or an alkyl group, having one terminal hydroxyl group and being water-insoluble, such as products with a variety of molecular weights and viscosities marketed by DOW Chemical Company (www.dow.com) under the trade mark UCON LB Fluids.

The base liquid may, alternatively or additionally, comprise an alcohol-(ROH—) started linear random copolymer of ethylene oxide and propylene oxide having a generalized formula:

RO—[CH(CH₃)CH₂—O—]ₘ[CH₂—CH₂—O]ₙH, (2)

where R is hydrogen or an alkyl group.

The base liquid may, alternatively or additionally, comprise an alcohol-(ROH—) started random copolymer of ethylene oxide and propylene oxide preferably comprising approximately equal amounts, that is approximately 50%, by weight of oxyethylene groups and oxypropylene groups, having one terminal hydroxyl group and being water-soluble at ambient temperature, that is at temperatures below approximately 40° C., such as products with equal amounts by weight of oxyethylene groups and oxypropylene groups and with a variety of molecular weights and viscosities marketed by DOW Chemical Company under the trade mark UCON 50-HB Fluids. For example, the base liquid may, alternatively or additionally, comprise a butanol-started random copolymer of ethylene oxide and propylene oxide comprising equal amounts by weight of oxyethylene groups and oxypropylene groups with a numbered average molecular weight of 3930, a viscosity of approximately 1020 cSt at 40° C. and a viscosity grade of approximately 1000 according to ISO 3448, such as a product marketed by DOW Chemical Company under the trade mark UCON 50-HB-5100.

The base liquid may, alternatively or additionally, comprise a diol-started random copolymer of ethylene oxide and propylene oxide preferably comprising approximately 75% by weight oxyethylene groups and, correspondingly, approximately 25% by weight oxypropylene groups, having two terminal hydroxyl groups (R═H) and being water-soluble at temperatures below approximately 75° C., such as products with a variety of molecular weights and viscosities marketed by DOW Chemical Company under the trade mark UCON 75-H Fluids. For example, the base liquid may, alternatively or additionally, comprise a diol-started random copolymer of ethylene oxide and propylene oxide comprising 75% by weight oxyethylene groups and 25% by weight oxypropylene groups with a numbered average molecular weight of 6950 and a viscosity of approximately 1800 cSt at 40° C., such as a product marketed by DOW Chemical Company under the trade mark UCON 75-H-9500.

The base liquid may, alternatively or additionally, comprise an alcohol-(ROH—) started random copolymer of ethylene oxide and propylene oxide preferably comprising approximately 40% by weight of oxyethylene groups and, correspondingly, approximately 60% by weight oxypropylene groups and being water-soluble, such as products with a variety of molecular weights and viscosities marketed by DOW Chemical Company under the trade mark SYNALOX 40. For example, the base liquid may, alternatively or additionally, comprise an alcohol-started random copolymer of ethylene oxide and propylene oxide comprising 40% by weight of oxyethylene groups and 60% by weight oxypropylene groups with a numbered average molecular weight of 5300, a viscosity of 1050 cSt at 40° C. and a viscosity grade of approximately 1000 according to ISO 3448 such as a product marketed by DOW Chemical Company under the trade mark SYNALOX 40-D700.

The base liquid may, alternatively or additionally, comprise a diol-started random copolymer of ethylene oxide and propylene oxide preferably comprising approximately 50% by weight of oxyethylene and, correspondingly, approximately 50% by weight oxypropylene groups with a kinematic viscosity of 960-1160 cSt (or mm²/s) at 40° C. ASTM D445 such as a product marketed by DOW Chemical Company under the trade mark SYNALOX 50-D700.

The gel former may comprise fumed silica, for example hydrophobic silica or hydrophilic silica, preferably having a BET (Brunauer, Emmett, Teller) surface between approximately 50 m²/g and approximately 400 m²/g, for example a hydrophilic fumed silica having a BET surface of 300 m²/g, such as a product marketed by Evonik Industries (www.evonik.com) under the trade mark Aerosil A300.

The gelling effect of the gel formers on the oils is accomplished by the formation of a network of the molecules of the gel former through hydrogen bonding via hydroxy groups or via van der Waals attraction between segments molecules of the gel former. The number and the strength of these bonds determines the gel strength, and the ability of the gel to support a load (critical yield stress).

The thixotropic balancing substance 338a may be a balancing gel comprising a balancing gel composition comprising

1) 85 to 97% by weight of a glycol ether component comprising one or more ethylene/propylene glycol copolymer ethers of the general formula (I) or the general (II) or mixtures thereof

R—O{[CH(CH3)CH2—O-]m[CH2-CH2-O-]n}H (I)

R1-(O—{[CH(CH3)CH2-O-]m[CH2-CH2-O-]n}H)2 (II)

wherein R is hydrogen or an alkyl group of 2-8 carbon atoms; R1 is an alkylene moiety of 2-8 carbon atoms in which the two substituents are not carried on the same carbon atom; m is the mole percentage of propylene glycol in the ethylene/propylene glycol copolymer moiety or moieties; and n is the mole percentage of ethylene glycol in the ethylene/propylene glycol copolymer moiety or moieties, wherein the ratio n:m is in the range from 35:65 to 80:20; each glycol copolymer compound having a number average molecular weight in the range of 2000-10000; and
2) 3 to 15% by weight of a fumed silica gel former; said balancing composition being visco-elastic and having a storage modulus (G′) between 1500 Pa and 5000 Pa at 22° C., a loss modulus (G″) smaller than the storage modulus up to a cross-over frequency of 10-40 Hz, and a Critical Yield Stress exceeding 2 Pa.

The number average molecular weight of the glycol ether component(s) may be in the range of 3000-10000. The ratio n:m may be in the range from 35:65 to 80:20, preferably in the range from 40:60 to 75:22, in particular from 40:60 to 60:40, such as 50:50. The fumed silica gel former may be a hydrophilic type fumed silica having a BET surface area of from 90 to 400 m²/g, preferably from 200 to 300 m²/g; or the fumed silica gel former is a hydrophobized type fumed silica having has a BET surface area of from 50 to 300 m²/g, preferably from 250 to 350 m²/g; or mixtures of such hydrophilic and hydrophobized type fumed silica gel formers. The glycol ether component(s) may exhibit a Viscosity Grade determined according to 1503448 of above 500, preferably in the range of 800-1200.

The compositions of the invention are typically made by mixing together the ingredients, if necessary under slight heating to below approximately 40° C.

Using base liquids and gel formers as described above, a series of exemplary balancing substances have been prepared, and evaluated in field tests using a model helicopters as will be described below. The compositions are shown in Table 1.

TABLE 1
Balancing Substance Formulations (in % by weight)

| Composition | | UCON 75- | UCON 50- | SYNALOX |
|---|---|---|---|---|
| # | Aerosil A300 | HB-9500 | HB-5100 | D50-700 |
| 1 | 4 | 0 | 96 | 0 |
| 2 | 4 | 0.5 | 95.5 | 0 |
| 3 | 4 | 0 | 0 | 96 |
| 4 | 4 | 0.5 | 0 | 95.5 |
| 5 | 5 | 0 | 95 | 0 |
| 6 | 5 | 0.5 | 94.5 | 0 |
| 7 | 5 | 0 | 0 | 95 |
| 8 | 5 | 0.5 | 0 | 94.5 |
| 9 | 6 | 0 | 94 | 0 |
| 10 | 6 | 0.5 | 93.5 | 0 |
| 11 | 6 | 0 | 0 | 94 |
| 12 | 6 | 0.5 | 0 | 93.5 |

Initially, the thixotropic balancing substance 338a fills, as indicated by a line denoted “a”, the chamber 335a to an even level. As the rotary system 340a rotates about its rotational axis 360a, the thixotropic balancing substance 338a liquefies owing to vibration in the rotary system 340a and flows upwards a circumferential balancing area 339a of the chamber 335a, as indicated by lines denoted “b” to “d”. The thixotropic balancing substance 338a distributes itself along the circumferential balancing area 339a, such that the vibration caused by the heavy spot 342a is reduced, as indicated by a line “e”. When the vibration is reduced, the thixotropic balancing substance 338a may maintain its position.

The circumferential balancing area 339a may comprise a nanostructure, said nanostructure being, for example, formed by a material, such as a varnish, comprising nanoparticles, or imprinted on said balancing.

FIG. 3 b) shows a corresponding view on the cylindrical chamber 335b at a particular point “e” in time. The rotary system 340b comprises the shaft 331b having the rotational axis 360b and the blades 341b. One of the blades 341b comprises the heavy spot 342b causing a CofR 361b. The chamber 335b comprises the circumferential balancing area 339b and is partially filled with an amount of a thixotropic balancing substance 338b. The thixotropic balancing substance 338b has distributed itself along the circumferential balancing area 339b, such that the CofR 361b moves to the rotational axis 360a and the vibration caused by the heavy spot 342b is reduced, as indicated by a line “e”. As can be seen, the thixotropic balancing substance 338b accumulated opposite the heavy spot 342b.

For maintenance work of the rotary system 340a; 340b, such as static balancing and RTB, it may be necessary to remove the vessel or at least the thixotropic balancing substance 338a, 338b, or otherwise disable the function of the thixotropic balancing substance 338a, 338b.

The chamber 335a may further comprise a weight body (not shown) being in contact with the thixotropic balancing substance 338a and contributing to balancing of the rotary system 340a. The weight body has, defined by a body size of the weight body, a body surface and a body weight, such that the weight body overcomes adhesion between the body surface and the thixotropic balancing substance 338a when the thixotropic balancing substance 338a is subjected to the vibration and changes into an agitated state. The body size ensures movability of the weight body in the chamber 335a with the thixotropic balancing substance 338a therein. The weight body may be a ball. The body size corresponds with a diameter of the ball. The diameter may be determined by a ratio between the body surface according to:

A=4pi r̂2, (3)

where r is a radius of the ball, accounting for surface structure, i.e. roughness, and adhesion, and a body volume according to:

V=4/3pi r̂3, (4)

where r is a radius of the ball, accounting for body density and body weight. For increasing radius r, the volume, and therefore body weight, increases faster than the body surface, and movability of the weight body in the chamber 335a increases. The weight body may comprise metal, for example steel, such as stainless steel.

In a test, a lift rotor of a model helicopter has been modified according to the preferred embodiment of the invention. A vessel having a diameter of 38 mm and a height of 40 mm has been coupled to a steel shaft of the lift rotor, having a diameter of 10 mm and a length of 194 mm. The vessel has been implemented as a cup-like lower part and a lid-like upper part. The upper part has been fastened to the lower part with four screws evenly spaced apart (90)°. The chamber has been filled with 28 g of a thixotropic balancing substance having a yield stress value greater than 2 Pa. The chamber has been located below the blades, as indicated by 235b in FIG. 2 b). As compared to the model helicopter without modification, the model helicopter with modification has taken off and flown with far less vibration and far more stability.

In another test, a lift rotor of another model helicopter has been modified according to the preferred embodiment of the invention. The conventional model helicopter is a make Align (www.align.com.tw)/ Robbe (www.robbe.de) V-helicopter, model T-Rex 600 Nitro Pro (KX016NPA) having a length of 1160 mm, height of 410 mm, main blade length of 600 mm, main rotor diameter of 1350 mm, tail rotor diameter of 240 mm, engine pinion gear of 20 T and a flying weight of approximately 3.20 kg (without fuel). Vessels comprising a chamber have been implemented as a cup-like lower part and a lid-like upper part. The upper part has been fastened to the lower part with a centre screw. For first embodiment of the vessel having a diameter of 60 mm and a height of 20 mm, a cup-like lower part and a lid-like upper part have been made from aluminum. For a second embodiment having a diameter of 115 mm and height of 25 mm, a cup-like lower part has been made from polyoxymethylene (POM, for example Delrin) and a lid-like upper part has been made from transparent polymethyl methacrylate (PMMA, poly methyl 2-methylpropenoate, acrylic glass, for example Plexiglas). The chambers have been filled with 0 g, 20 g or 30 g of a thixotropic balancing substance according to composition number 5, as shown in Table 1. The vessel of the first embodiment or the second embodiment, located above the blades, as indicated by 237b in FIG. 2 b), has been attached to a shaft of the lift rotor.

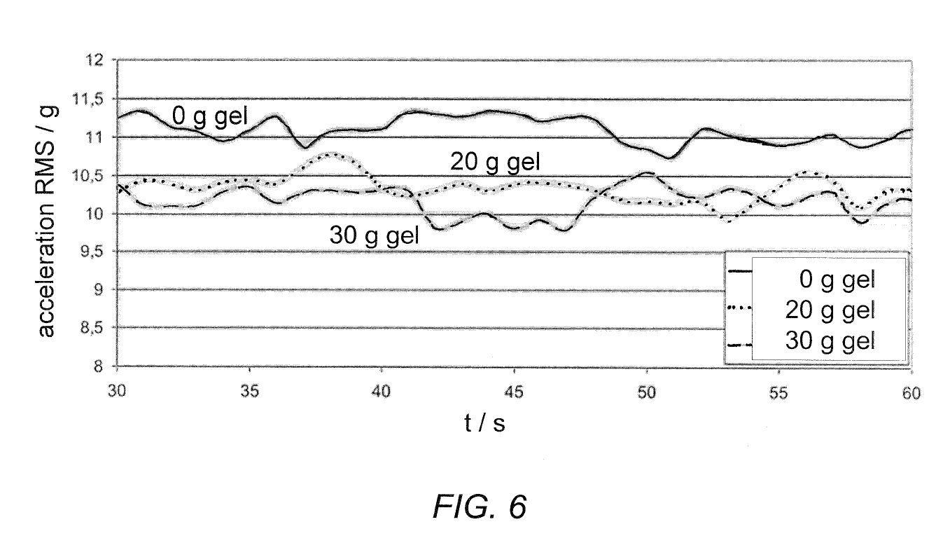

FIG. 6 shows, for the vessel of the second embodiment, a comparative representation of root mean square (RMS) accelerations in acceleration of gravity (g), that is approximately 9.81 m/s², of the model helicopter without and with a balancing substance over time (t) in seconds (s) at 1480 rpm. The representation derives from experimental data taken with an acceleration sensor module make Crossbow (www.xbow.com), model CXL10HF3 attached to the helicopter in a pilot's cockpit. Alternatively, the sensor module may be attached to a skid suspension of the helicopter, for example. The curve enveloping 11.0 g corresponds with 0.0 g of balancing substance. The curve enveloping 10.5 g corresponds with 20.0 g of balancing substance. The curve enveloping 10.0 g corresponds with 30.0 g of balancing substance. As can be seen from FIG. 6, for 20 g and 30 g of balancing substance, accelerations, and thus vibrations, are reduced as compared to 0 g of balancing substance.

For subjective evaluation by model's pilot, tests have been made with 0 g of balancing substance at approximately 1480 rpm, 30 g of balancing substance at approximately 1650 rpm, 60 g of balancing substance at approximately 1650 rpm and 80 g of balancing substance at approximately 1650 rpm have been made. The evaluation on a ranking from 0 for the worst case to 8 for the best case is shown in Table 2.

TABLE 2
Subjective Evaluation by Model's Pilot (Ranking
from 0 for the Worst Case to 8 for the Best Case)

| | Balancing | | |
|---|---|---|---|
| Test # | Substance | Speed | Ranking |
| 1 | 0 g | 1480 rpm | 1 |
| 2 | 30 g | 1650 rpm | 4.3 |
| 3 | 60 g | 1650 rpm | 6.3 |
| 4 | 80 g | 1650 rpm | 7 |

As compared to the model helicopter without modification, the model helicopter with balancing substance has taken off and flown with far less vibration and far more stability as reflected by the subjective evaluation.

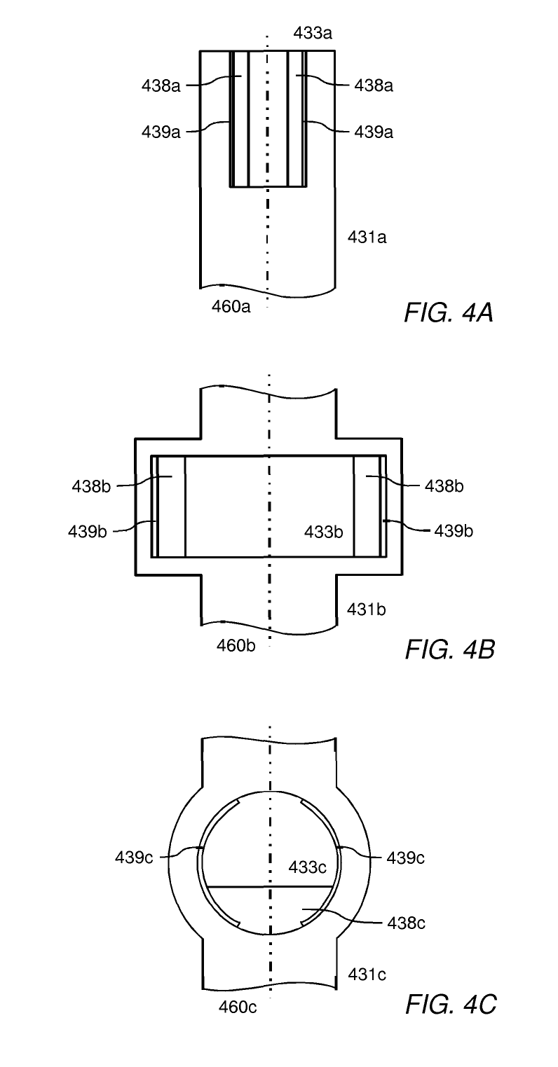

FIG. 4 a) to c) show cross-sectional schematic views of several embodiments of a chamber in a shaft.

FIG. 4 a) shows a shaft 431a having a rotational axis 460a. The shaft 431a comprises a chamber 433a with a circumferential balancing area 439a. The chamber 433a is partially filled with an amount of a thixotropic balancing substance 438a distributed on the circumferential balancing area 439a.

FIG. 4 b) shows a shaft 431b having a rotational axis 460b. The shaft 431b comprises a cylindrical chamber 433b with a circumferential balancing area 439b. A diameter of the chamber 433b is greater than a general diameter of the shaft 431b. The chamber 433b is partially filled with an amount of a thixotropic balancing substance 438b distributed on the circumferential balancing area 439b.

FIG. 4 c) shows a shaft 431c having a rotational axis 460c. The shaft 431c comprises a chamber 433c with a circumferential balancing area 439c. A diameter of the chamber 433c is greater than a general diameter of the shaft 431c. The chamber 433c is partially filled with an amount of a thixotropic balancing substance 438c.

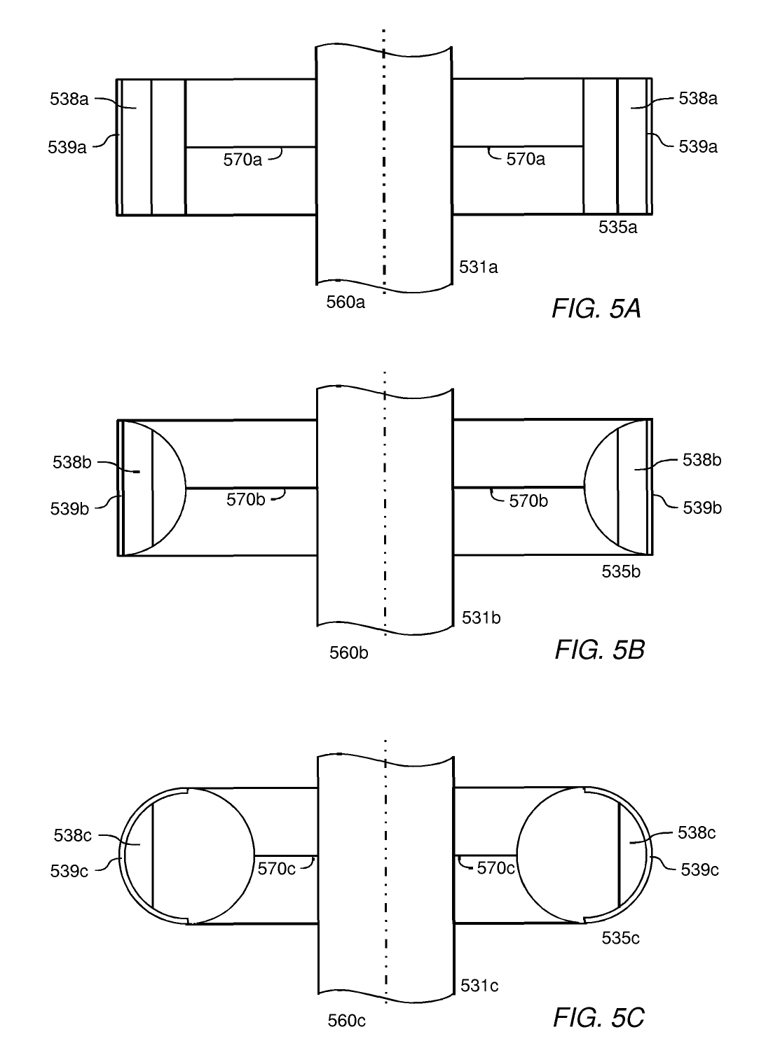

FIG. 5 a) to c) show cross-sectional schematic views of several embodiments of a chamber in a vessel.

FIG. 5 a) shows a shaft 531a having a rotational axis 560a. A vessel comprising a chamber 535a is coupled to the shaft 531a via a disc 570a or spokes 570a. The vessel is connected to the disc 570a or spokes 570a in a central position between an upper edge and a lower edge of the vessel. Alternatively, the vessel may be connected to the disc 570a or spokes 570a at another position between the upper edge and the lower edge. The two or more spokes 570a may be evenly spaced apart from each other. The chamber 535a has a circumferential balancing area 539a and a rectangular cross section. The chamber 535a is partially filled with an amount of a thixotropic balancing substance 538a distributed on the circumferential balancing area 539a.

FIG. 5 b) shows a shaft 531b having a rotational axis 560b. A vessel comprising a chamber 535b is coupled to the shaft 531b via a disc 570b or spokes 570b. The vessel is connected to the disc 570b or spokes 570b in a central position between an upper edge and a lower edge of the vessel. Alternatively, the vessel may be connected to the disc 570b or spokes 570b at another position between the upper edge and the lower edge. The two or more spokes 570b may be evenly spaced apart from each other. The chamber 535b has a circumferential balancing area 539b and a semicircle-shaped cross section. Alternatively, the cross section may be bell-shaped. The chamber 535b is partially filled with an amount of a thixotropic balancing substance 538b distributed on the circumferential balancing area 539b.

FIG. 5 c) shows a shaft 531c having a rotational axis 560c. A vessel comprising a chamber 535c is coupled to the shaft 531c via a disc 570c or spokes 570c. The vessel is connected to the disc 570c or spokes 570c in a central position between an upper edge and a lower edge of the vessel. Alternatively, the vessel may be connected to the disc 570c or spokes 570c at another position between the upper edge and the lower edge. The two or more spokes 570c may be evenly spaced apart from each other. The chamber 535c has a circumferential balancing area 539c and a circular cross section. The chamber 535c is partially filled with an amount of a thixotropic balancing substance 538c distributed on the circumferential balancing area 539c.

Embodiments of the inventions comprise a corresponding apparatus, that may carry out the method.

Embodiments of the inventions comprise a corresponding system, that may carry out the method, possibly across a number of devices.

Although specific embodiments have been illustrated and described herein, it will be appreciated by those of ordinary skill in the art, that any arrangement which is calculated to achieve the same purpose may be substituted for the specific embodiments shown. It is to be understood, that the above description is intended to be illustrative and not restrictive. This application is intended to cover any adaptations or variations of the invention. Combinations of the above embodiments and many other embodiments will be apparent to those of skill in the art upon reading and understanding the above description. The scope of the invention includes any other embodiments and applications in which the above structures and methods may be used. The scope of the invention should, therefore, be determined with reference to the appended claims along with the full scope of equivalents to which such claims are entitled.

1-15. (canceled)

16. A method for reducing vibration in a rotary system (140; 240a; 240b; 340a; 340b) of an aircraft (100), for example an aeroplane or a rotorcraft, such as a helicopter, comprising:
balancing said rotary system (140; 240a; 240b; 340a; 340b), characterized by
providing a circular chamber (232a, 233a, 234b, 235a, 236a, 237a; 232b, 233b, 234b, 235b, 237b; 335a; 335b; 433a; 433b; 433c; 535a; 535b; 535c) having a fulcrum on an axis (260a; 260b; 360a; 360b; 460a; 460b; 460c; 560a; 560b; 560c) of a shaft (131; 231a; 231b; 331a; 331b; 431a; 431b; 431c; 531a; 531b; 531c) of said rotary system (140; 240a; 240b; 340a; 340b) and being partially filled with an amount of a thixotropic balancing substance (338a; 338b; 438a; 438b; 438c; 538a; 538b; 538c) having a yield stress value between 1 Pa and 400 Pa.

17. The method of claim 16, wherein:
said chamber (233a, 234b, 235a, 236a, 237a; 335a; 335b; 433a; 433b; 433c) is cylindrical.

18. The method of claim 16, wherein:
said chamber (232b, 233b, 234b, 235b, 237b; 535a; 535b; 535c) is annular.

19. The method of claim 18, wherein:
said chamber (232b, 233b, 234b, 235b, 237b; 535a; 535b; 535c) has a cross section being rectangular (535a), semicircle-shaped (535b), bell-shaped (535b) or circular (535c).

20. The method of claim 16, wherein:
said chamber (237a; 237b) is located above blades (241a; 241b) of said rotary system (140; 240a; 240b); or
said chamber (235a; 235b) is located below said blades (241a; 241b); or
said chamber (235a; 235b) is located above a power plant (230a; 230b) of said aircraft (100); or
said chamber (232a; 232b) is located below said power plant (230a; 230b).

21. The method of claim 16, wherein:
said chamber (233a, 234b, 235a, 236a, 237a; 232b, 233b, 234b, 235b, 237b; 335a; 335b; 433a; 433b; 433c; 535a; 535b; 535c) comprises a circumferential balancing area (339a; 339b; 439a; 439b; 439c; 539a; 539b; 539c) with a nanostructure, said nanostructure being formed by a material or a varnish, comprising nanoparticles, or imprinted on said balancing area (339a; 339b; 439a; 439b; 439c; 539a; 539b; 539c).

22. The method of claim 16, wherein:
said shaft (131; 231a; 231b; 331a; 331b; 431a; 431b; 431c; 531a; 531b; 531c) comprises metal or steel or aluminium, or composite material or glass-fibre-reinforced material or carbon-fibre-reinforced material, or synthetic material or plastics or plexiglass.

23. The method of claim 16, wherein:
said chamber (232a, 233a, 234a, 235a, 236a, 237a; 433a; 433b; 433c) is situated in said shaft (131; 231a; 431a; 431b; 431c).

24. The method of claim 23, wherein:
said shaft (131; 231a; 431a; 431b; 431c) replaces an original shaft of said rotary system (140; 240a).

25. The method of claim 23, wherein:
said chamber (232a, 233a, 234a, 235a, 236a, 237a; 433a; 433b; 433c) extends substantially along said shaft (131; 231a; 431a; 431b; 431c).

26. The method of claim 16, wherein:
said chamber (232b, 233b, 234b, 235b, 237b; 335a; 335b; 535a; 535b; 535c) is situated in a vessel being coupled to said shaft (131; 231a; 331a; 331b; 531a; 531c; 531c).

27. The method of claim 26, wherein:
said vessel supplements said rotary system (140; 240b; 340a; 340b).

28. The method of claim 26, wherein:
said vessel has a diameter of between 0.1 m and 10 m.

29. The method of claim 26, wherein:
said vessel has a diameter of between 0.2 m and 1.5 m.

30. The method of claim 26, wherein:
said vessel has a diameter of between 0.5 m and 1 m.

31. The method of claim 26, wherein:
said vessel has a diameter of 0.75 m.

32. The method of claim 26, wherein:
said vessel comprises metal or steel or aluminium, or composite material or glass-fibre-reinforced material or carbon-fibre-reinforced material, or synthetic material or plastics or plexiglass.

33. The method of claim 26, wherein:
said vessel is coupled to said shaft (131; 231a; 331a; 331b) via said blades (141), a disc (570a; 570b; 570c) or spokes (570a; 570b; 570c).

34. The method of claim 33, wherein:
said spokes (570a; 570b; 570c) are evenly spaced apart from each other.

35. The method of claim 16, wherein:
said thixotropic balancing substance (338a; 338b; 438a; 438b; 438c; 538a; 538b; 538c) has a yield stress value between 2 Pa and 260 Pa.

36. The method of claim 16, wherein:
said thixotropic balancing substance (338a; 338b; 438a; 438b; 438c; 538a; 538b; 538c) has a yield stress value of 30 Pa.

37. The method of claim 16, wherein:
said amount of said thixotropic balancing substance (338a; 338b; 438a; 438b; 438c; 538a; 538b; 538c) is between 0.01 kg and 20 kg, for example between 0.1 kg and 2 kg, preferably between 0.2 kg and 1 kg, such as 0.5 kg; or
said chamber (232a, 233a, 234b, 235a, 236a, 237a; 232b, 233b, 234b, 235b, 237b; 335a; 335b; 433a; 433b; 433c; 535a; 535b; 535c) is filled with said amount of said thixotropic balancing substance (338a; 338b; 438a; 438b; 438c; 538a; 538b; 538c) to between 1% and 90%, for example between 10% and 80%, preferably between 25% and 75%, such as 50%; or
both.

38. An apparatus for reducing vibration in a rotary system (140; 240a; 240b; 340a; 340b) of an aircraft (100), characterized by
a circular chamber (232a, 233a, 234b, 235a, 236a, 237a; 232b, 233b, 234b, 235b, 237b; 335a; 335b; 433a; 433b; 433c; 535a; 535b; 535c) having a fulcrum on an axis (260a; 260b; 360a; 360b; 460a; 460b; 460c; 560a; 560b; 560c) of a shaft (131; 231a; 231b; 331a; 331b; 431a; 431b; 431c; 531a; 531b; 531c) of said rotary system (140; 240a; 240b; 340a; 340b) and being partially filled with an amount of a thixotropic balancing substance (338a; 338b; 438a; 438b; 438c; 538a; 538b; 538c) having a yield stress value between 1 Pa and 400 Pa.

39. A system for reducing vibration in a rotary system (140; 240a; 240b; 340a; 340b) of an aircraft (100), comprising:
balancing said rotary system (140; 240a; 240b; 340a; 340b), characterized by
providing a circular chamber (232a, 233a, 234b, 235a, 236a, 237a; 232b, 233b, 234b, 235b, 237b; 335a; 335b; 433a; 433b; 433c; 535a; 535b; 535c) having a fulcrum on an axis (260a; 260b; 360a; 360b; 460a; 460b; 460c; 560a; 560b; 560c) of a shaft (131; 231a; 231b; 331a; 331b; 431a; 431b; 431c; 531a; 531b; 531c) of said rotary system (140; 240a; 240b; 340a; 340b) and being partially filled with an amount of a thixotropic balancing substance (338a; 338b; 438a; 438b; 438c; 538a; 538b; 538c) having a yield stress value between 1 Pa and 400 Pa.
